(19) United States
(12) Patent Application Publication
(10) Pub. No.: US 2014/0374512 A1
(43) Pub. Date: Dec. 25, 2014

(54) ELECTROMAGNETIC FUEL INJECTION VALVE

(71) Applicant: KEIHIN CORPORATION, SHINJUKU-KU, TOKYO (JP)

(72) Inventors: Takuya Honjo, Shioya-gun (JP); Jun Sato, Shioya-gun (JP); Toshinori Kuzuma, Shioya-gun (JP)

(73) Assignee: KEIHIN CORPORATION, SHINJUKU-KU, TOKYO (JP)

(21) Appl. No.: 14/376,676

(22) PCT Filed: Jan. 8, 2013
(86) PCT No.: PCT/JP2013/050052

§ 371 Date: Aug. 5, 2014

(30) Foreign Application Priority Data
Feb. 13, 2012 (JP) 2012-028896

(51) Int. Cl. F02M 51/06

(52) U.S. Cl. CPC F02M 51/061
USPC 239/585.1

(57) ABSTRACT

An electromagnetic fuel injection valve includes a coil assembly fitted around an outer periphery of a fixed core, a coil housing forming a magnetic path between a valve housing and the fixed core while surrounding the coil assembly, and a synthetic resin covering layer molded so as to cover the coil housing, wherein a yoke supporting a front end of the coil assembly is formed on an outer periphery of the valve housing, the coil housing is formed from a body portion surrounding the coil assembly while being magnetically connected to the yoke and an end wall portion formed integrally with the body portion and fitted around an outer periphery of the fixed core, and a shoulder portion is formed on the outer periphery of the fixed core, the shoulder portion receiving the end wall portion and restricting the position of the coil housing in an axial direction.

### TECHNICAL FIELD

The present invention relates to an improvement of an electromagnetic fuel injection valve that includes a valve body that has a nozzle member having a valve seat, a tubular valve housing made of a magnetic material and connectedly provided at a rear end of the nozzle member, and a fixed core linked to a rear end of the valve housing via a non-magnetic tubular body, a valve member that is housed within the valve housing so as to be capable of moving between the valve seat and the fixed core, a return spring that is provided in a compressed state between the fixed core and the valve member and urges the valve member in a direction in which the valve member is seated on the valve seat, a coil assembly that is disposed so as to surround from the fixed core to the valve housing and, when energized, generates an attracting force due to a magnetic force between the fixed core and the valve member, a coil housing that forms a magnetic path between the valve housing and the fixed core while surrounding the coil assembly, and a synthetic resin covering layer that is molded so as to cover the coil housing.

### BACKGROUND ART

Such an electromagnetic fuel injection valve is already known, as disclosed in Patent Document 1 below.

### RELATED ART DOCUMENTS

### Patent Document

Patent Document 1: Japanese Patent Application Laid-open No. 2005-282458

### SUMMARY OF THE INVENTION

### Problems to be Solved by the Invention

In a conventional electromagnetic fuel injection valve, a stopper ring exclusively used for receiving the front end of a coil housing is fitted around the outer periphery of a valve housing, and when molding a covering layer made of a synthetic resin, molding pressure acting on the coil housing is received by the stopper ring, thus restricting the position of the coil housing in the axial direction.

In this way, use of the stopper ring exclusively used for restricting the position of the coil housing in the axial direction results in an increase in the number of components and the number of assembly steps, thus influencing the cost.

The present invention has been accomplished in light of such circumstances, and it is an object thereof to provide an electromagnetic fuel injection valve that can restrict the position of a coil housing in the axial direction against molding pressure of a covering layer made of a synthetic resin without using a stopper ring exclusively used therefor, thus contributing to a reduction in cost.

### Means for Solving the Problems

In order to attain the above object, according to a first aspect of the present invention, there is provided an electromagnetic fuel injection valve comprising a valve body that has a nozzle member having a valve seat, a tubular valve housing made of a magnetic material and connectedly provided at a rear end of the nozzle member, and a fixed core linked to a rear end of the valve housing via a non-magnetic tubular body, a valve member that is housed within the valve housing so as to be capable of moving between the valve seat and the fixed core, a return spring that is provided in a compressed state between the fixed core and the valve member and urges the valve member in a direction in which the valve member is seated on the valve seat, a coil assembly that is disposed so as to surround from the fixed core to the valve housing and, when energized, generates an attracting force due to a magnetic force between the fixed core and the valve member, a coil housing that forms a magnetic path between the valve housing and the fixed core while surrounding the coil assembly, and a synthetic resin covering layer that is molded so as to cover the coil housing, characterized in that a flange-shaped yoke supporting a front end of the coil assembly is formed on an outer periphery of the valve housing, the coil housing being formed from a body portion surrounding the coil assembly while being magnetically connected to the yoke and an end wall portion formed integrally with the body portion and fitted around an outer periphery of the fixed core, and a shoulder portion is formed on the outer periphery of the fixed core, the shoulder portion receiving the end wall portion and restricting the position of the coil housing in an axial direction.

Further, according to a second aspect of the present invention, in addition to the first aspect, the end wall portion and the coil assembly are formed so that the end wall portion abuts against a rear end face of the coil assembly.

Furthermore, according to a third aspect of the present invention, in addition to the first or second aspect, the covering layer is formed by injecting a synthetic resin via a gate disposed to the rear of the end wall portion.

Moreover, according to a fourth aspect of the present invention, in addition to any one of the first to third aspects, a through hole is provided in the body portion, the through hole making a synthetic resin penetrate the coil assembly when molding the covering layer.

Further, according to a fifth aspect of the present invention, in addition to the fourth aspect, the body portion is fitted around an outer periphery of the yoke, and a gap is provided in the fitted part, the gap enabling the synthetic resin to flow when molding the covering layer.

### Effects of the Invention

In accordance with the first aspect of the present invention, when molding the covering layer using a synthetic resin, molding pressure acts on a rear end face, having a wide pressure-receiving area, of the end wall portion of the coil housing, but since the end wall portion is supported by the shoulder portion on the outer periphery of the fixed core, movement of the coil housing in the axial direction is prevented against the above pressure, thus stabilizing the position thereof in the axial direction. Therefore, it is unnecessary to use a stopper ring exclusively used for restricting the position of the coil housing in the axial direction, thus reducing the number of components and the number of assembly steps and thereby reducing the cost.

In accordance with the second aspect of the present invention, since the end wall portion of the coil housing is supported by wide supporting faces of the shoulder portion and the coil assembly due to abutment against the rear end face of the coil assembly, not only is it possible to firmly prevent movement of the coil housing in the axial direction, but it is also possible to prevent deformation of the coil housing due to the pressure and at the same time it is possible to firmly retain a bobbin between the end wall portion and the yoke.

In accordance with the third aspect of the present invention, when molding the covering layer, molten synthetic resin that has been injected into the gate disposed to the rear of the end wall portion flows from the end wall portion toward the front end of the body portion around the coil housing; accompanying this, a forward thrust acts on the coil housing, and this also presses and retains the end wall part against the shoulder portion of the fixed core, thus further stabilizing the position of the coil housing in the axial direction.

In accordance with the fourth aspect of the present invention, when molding the covering layer, the synthetic resin can be made to flow into the interior of the coil housing via the through hole thereof to thus make it penetrate the coil assembly, thereby enabling retention of the coil assembly and insulation of the coil to be achieved.

In accordance with the fifth aspect of the present invention, when molding the covering layer, part of the synthetic resin that has flowed into the interior of the coil housing via the through hole thereof flows, together with air within the coil housing, outside the coil housing through the gap between the yoke and the coil housing; it is thus possible to tightly pack the interior of the coil housing with the synthetic resin, thereby enabling good retention of the coil assembly and insulation of the coil to be achieved.

### BRIEF DESCRIPTION OF DRAWINGS

FIG. 1 is a vertical sectional view of an electromagnetic fuel injection valve related to the present invention. (first embodiment)

FIG. 2 is an enlarged view of part 2 in FIG. 1. (first embodiment)

FIG. 3 is a perspective view of a coil housing in FIG. 2. (first embodiment)

### EXPLANATION OF REFERENCE NUMERALS AND SYMBOLS

I Electromagnetic fuel injection valve
g Gate
1 Valve body
2 Nozzle member
3 Valve housing
5 Fixed core
5D Shoulder portion (annular shoulder portion)
7 Valve seat
20 Coil assembly
21a Rear end face of coil assembly (rear end face of bobbin 21)
23 Coil housing
23a Body portion
23b End wall portion
24 Yoke
26 Covering layer
29 Through hole
33 Gap

### MODE FOR CARRYING OUT THE INVENTION

A mode for carrying out the present invention is explained below by reference to the attached drawings.

### First Embodiment

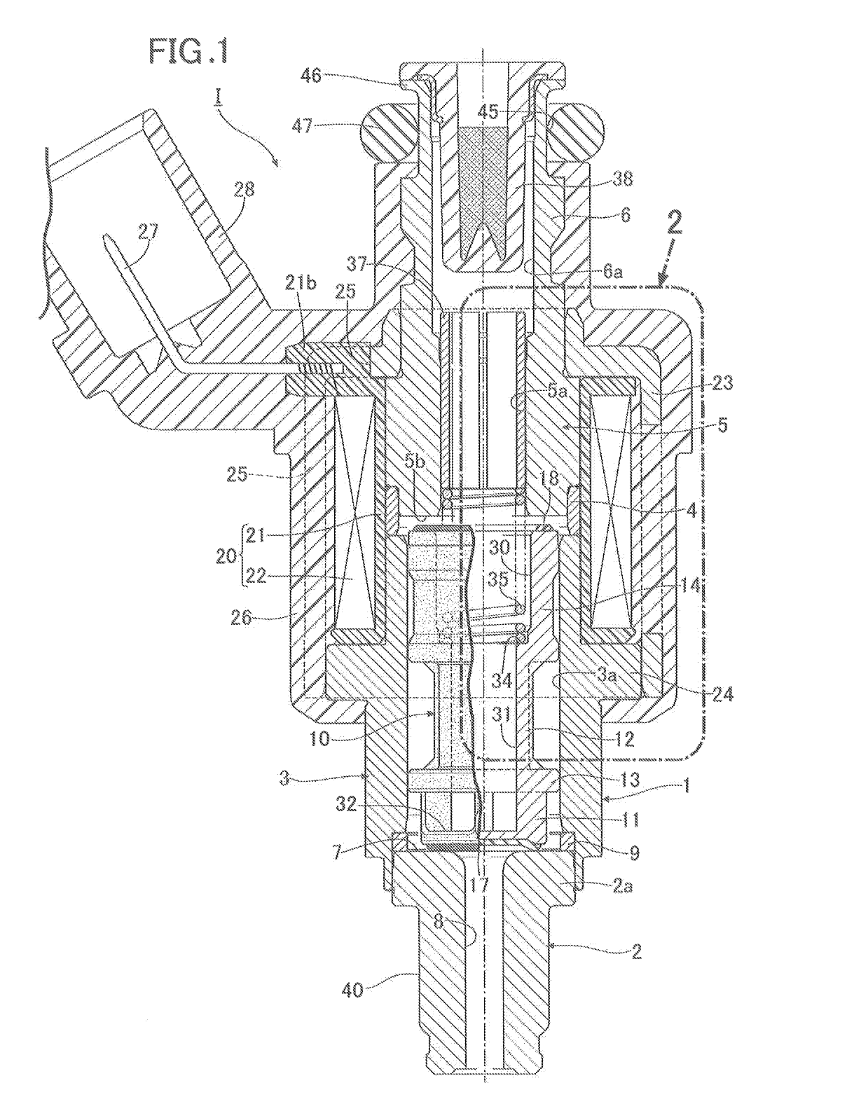

First, in FIG. 1, an electromagnetic fuel injection valve (hereinafter, simply called an injection valve) I of the present invention is provided on an engine intake tube and injects gaseous fuel into the intake tube during an engine intake stroke. A valve body 1 of this injection valve I is formed from a cylindrical nozzle member 2, a hollow cylindrical valve housing 3, made of a magnetic material, having a front end part fitted and bonded by welding to an outer peripheral face of a flange portion 2a at the rear end of the nozzle member 2, a hollow cylindrical fixed core 5 connectedly provided integrally with the rear end of the valve housing 3 via a non-magnetic tubular body 4, and a hollow cylindrical fuel inlet tube 6 connectedly provided integrally with the rear end of the fixed core 5. The fixed core 5 is formed so that its internal diameter is smaller than the internal diameter of the valve housing 3, and an attracting face 5b at the front end opposes a valve member 10, which is described later, of the valve housing 3.

The nozzle member 2 has a flat valve seat 7 facing the interior of the valve housing 3, and a nozzle hole 8 extending through a central part of the valve seat 7 and opening on a front end face of the nozzle member 2, and an annular shim 9 for adjusting the position of the valve seat 7 is disposed between the nozzle member 2 and the valve housing 3.

An inner peripheral face of the valve housing 3 is used as a sliding guide face 3a, and the valve member 10, which is made of a magnetic material, is slidably fitted to the sliding guide face 3a.

This valve member 10 is formed by integrally and coaxially connecting in sequence from the front end side a short shaft part 11, a first journal part 13 having a larger diameter than that of the short shaft part 11 and slidably fitted to the sliding guide face 3a, a long shaft part 12 having a smaller diameter than that of the short shaft part 11 and a larger length than that thereof, and a second journal part 14 having a larger diameter than that of the short shaft part 11 and slidably fitted to the sliding guide face 3a. A seating member 17, made of rubber, that can be seated on the valve seat 7 is joined by baking to a front end face of the short shaft part 11.

An annular cushion member 18, made of rubber, is joined by baking to a rear end face of the second journal part 14, that is, a rear end face of the valve member 10, the cushion member 18 opposing the attracting face 5b of the fixed core 5. A predetermined gap corresponding to a valve opening stroke of the valve member 10 is set between opposing faces of the cushion member 18 and the fixed core 5 when the seating member 17 is seated on the valve seat 7.

A coil assembly 20 is disposed from the region of the valve housing 3 in which the second journal part 14 is fitted, to the fixed core 5 so as to surround same. This coil assembly 20 is formed from a bobbin 21, which is fitted on the outer peripheries of the valve housing 3, the non-magnetic tubular body 4, and the fixed core 5, and a coil 22 wound around the outer periphery of the bobbin 21, and a terminal retaining portion 21b for retaining a coupler terminal 27 connected to the coil 22 is formed integrally with a rear end part of the bobbin 21 so as to protrude sideways from the bobbin 21. The position of this coil assembly 20 is restricted in the axial direction by the bobbin 21 being supported on a rear end face of a flange-shaped yoke 24 formed integrally with the outer periphery of the valve housing 3.

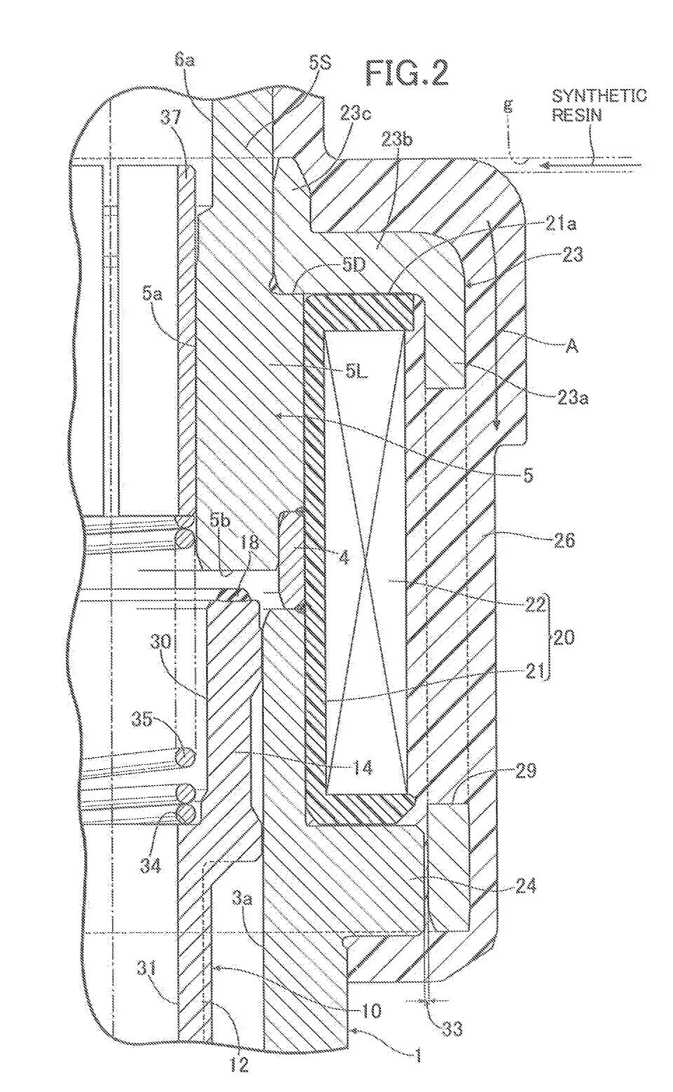

As shown in FIG. 2, the fixed core 5 includes a large diameter portion 5L having the bobbin 21 fitted around the outer periphery and, between the large diameter portion 5L and the fuel inlet tube 6, a small diameter portion 5S connected to the large diameter portion 5L via a rear-facing annular shoulder portion 5D, the annular shoulder portion 5D being formed so as to be flush with the rear end face 21a of the bobbin 21.

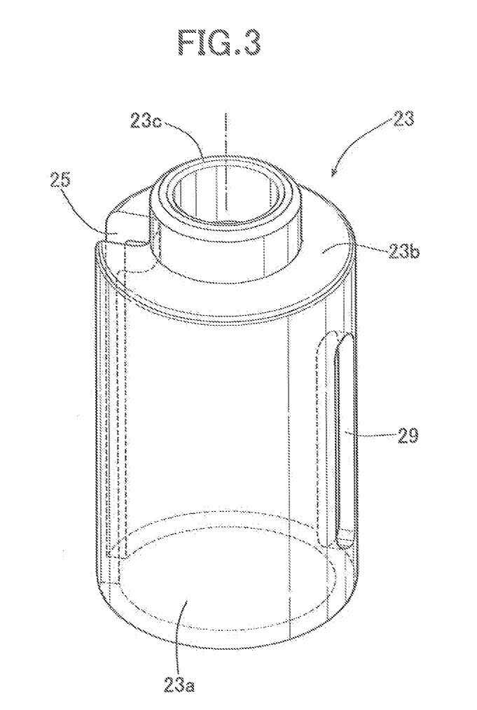

A coil housing 23 made of a magnetic material is disposed on the outer periphery of the coil assembly 20 so as to cover it. This coil housing 23 is formed, as shown in FIG. 2 and FIG. 3, from a body portion 23a having an open front end face, an end wall portion 23b bending radially inwardly from the rear end of the body portion 23a, and a mounting boss 23c formed in a central part of the end wall portion 23b. A slit 25 extending along the body portion 23a and the end wall portion 23b is provided in one side of the coil housing 23, and a through hole 29 extending in the axial direction is provided in the other side of the body portion 23a.

When attaching this coil housing 23, while covering the outer periphery of the coil assembly 20 with the body portion 23a from the rear, the mounting boss 23c is press fitted onto the small diameter portion 5S of the fixed core 5, an inner end face of the end wall portion 23b is made to abut against the annular shoulder portion 5D and the rear end face 21a of the bobbin 21, and a front end part of the body portion 23a is fitted around the outer peripheral face of the yoke 24 across a gap 33. In this process, the terminal retaining portion 21b of the bobbin 21 is inserted into the slit 25 of the coil housing 23.

In this way, the coil assembly 20 and the coil housing 23 are mounted on the valve body 1. A covering layer 26, made of a synthetic resin, providing a continuous covering from the front end face of the yoke 24 to the outer peripheral faces of the coil housing 23 and the fuel inlet tube 6 is formed by molding, and in this process a coupler 28 projecting toward one side of the covering layer 26 and retaining the coupler terminal 27 is also integrally molded.

When molding the covering layer 26 and the coupler 28 using a synthetic resin, molten synthetic resin is injected into a cavity, corresponding to the covering layer 26 and the coupler 28, of a mold, which is not illustrated, holding the valve body 1. In this process, molding pressure acts on a rear end face of the end wall portion 23b, which has the widest pressure-receiving area in the axial direction among those of the coil housing 23, but since the end wall portion 23b is supported by a rear end face of the annular shoulder portion 5D on the outer periphery of the fixed core 5, movement of the coil housing 23 in the axial direction is prevented against the above pressure, thus stabilizing the position thereof in the axial direction. Therefore, it is unnecessary to use a stopper ring exclusively used for restricting the position of the coil housing 23 in the axial direction, thus reducing the number of components and the number of assembly steps and thereby reducing the cost.

Moreover, since the end wall portion 23b is also supported by the rear end face 21a of the bobbin 21, that is, it is supported by wide supporting faces of the annular shoulder portion 5D and the bobbin 21, not only is it possible to firmly prevent movement of the coil housing 23 in the axial direction, but it is also possible to prevent deformation of the coil housing 23 due to the pressure and at the same time it is possible to firmly retain the bobbin 21 between the end wall portion 23b and the yoke 24.

When molding the covering layer 26, molten synthetic resin flows into the interior of the coil housing 23 through the slit 25 and the through hole 29 of the coil housing 23 to thus penetrate the coil assembly 20. In this process, part of the synthetic resin that has flowed into the coil housing 23 flows, together with air within the coil housing 23, outside the coil housing 23 through the gap 33 between the yoke 24 and the coil housing 23, and it is thus possible to tightly pack the interior of the coil housing 23 with the synthetic resin, thereby enabling retention of the coil assembly 20 and insulation of the coil 22 to be achieved.

Furthermore, when molding the covering layer 26, it is desirable for a gate g (FIG. 2) opening in the mold cavity to be disposed at a position to the rear of the end wall portion 23b of the coil housing 23, the mold cavity corresponding to the covering layer 26 and the coupler 28. Molten synthetic resin injected into the cavity through the gate g flows as shown by arrow A in FIG. 2 from the end wall portion 23b toward the front end of the body portion 23a, in particular around the coil housing 23, accompanying this a forward thrust acts on the coil housing 23, this also presses and retains the end wall portion 23b against the rear end faces of the annular shoulder portion 5D and the bobbin 21, and it is thus possible to stabilize the position of the coil housing 23 in the axial direction.

Referring again to FIG. 1, the valve member 10 is provided with a large diameter lengthwise hole 30 starting on the rear end face and finishing just before a front end face of the first journal part 13, a small diameter lengthwise hole 31 starting at the bottom of the large diameter lengthwise hole 30 and finishing just before a front end face of the short shaft part 11, and a plurality of sideways holes 32 via which the small diameter lengthwise hole 31 opens on the outer peripheral face of the short shaft part 11.

The large diameter lengthwise hole 30 communicates with a hollow portion 5a of the fixed core 5, and a rear-facing annular step part formed between the large diameter lengthwise hole 30 and the small diameter lengthwise hole 31 is defined as a spring seat 34.

On the other hand, a hollow retainer 37 is fitted to an inner peripheral face of the hollow portion 5a of the fixed core 5, the hollow retainer 37 being formed from a spring pin supporting, between itself and the spring seat 34, a return spring 35 urging the valve member 10 toward the valve seat 7, and a fuel filter 38 is fitted into an inlet of a hollow portion 6a of the fuel inlet tube 6 communicating with the hollow portion 5a of the fixed core 5.

An annular rear seal groove 45 is defined on the outer periphery of a rear end part of the fuel inlet tube 6 by a flange 46 formed at the rear end of the fuel inlet tube 6 and a rear end face of the covering layer 26, and an O ring 47 is fitted into the rear seal groove 45, the O ring 47 being in intimate contact with an inner peripheral face of a fuel distribution pipe (not illustrated) fitted onto the outer periphery of the fuel inlet tube 6.

In a state in which the coil 22 is de-energized, the valve member 10 is pressed forward by virtue of the urging force of the return spring 35, and the seating member 17 is seated on the valve seat 7. In this state, gaseous fuel that has been supplied from the fuel distribution pipe, which is not illustrated, to the fuel inlet tube 6 is filtered by means of the fuel filter 38, passes through the hollow retainer 37 and the large diameter lengthwise hole 30, the small diameter lengthwise hole 31, and the sideways holes 32 of the valve member 10, and is held in readiness within the valve housing 3.

In this process, the set load of the return spring 35 and the pressure of the gaseous fuel act on the valve member 10 as a valve-closing force, thus pressing the seating member 17 in the direction in which it is seated on the valve seat 7 and closing the nozzle hole 8.

When the coil 22 is energized by passing an electric current, the magnetic flux generated thereby runs in sequence through the coil housing 23, the yoke 24, the valve housing 3, the second journal part 14, the fixed core 5, and the coil housing 23, the magnetic force makes the valve member 10 be attracted by the fixed core 5 against the set load of the return spring 35, and the rubber cushion member 18 of the valve member 10 abuts against the front end face of the fixed core 5, thus restricting the limit of opening of the seating member 17 with respect to the valve seat 7.

The present invention is not limited to the above embodiment and may be modified in a variety of ways as long as the modifications do not depart from the spirit and scope thereof. For example, the present invention can also be applied to an electromagnetic fuel injection valve for use with a liquid fuel such as gasoline.

1. An electromagnetic fuel injection valve comprising a valve body that has a nozzle member having a valve seat, a tubular valve housing made of a magnetic material and connectedly provided at a rear end of the nozzle member, and a fixed core linked to a rear end of the valve housing via a non-magnetic tubular body, a valve member that is housed within the valve housing so as to be capable of moving between the valve seat and the fixed core, a return spring that is provided in a compressed state between the fixed core and the valve member and urges the valve member in a direction in which the valve member is seated on the valve seat, a coil assembly that is disposed so as to surround from the fixed core to the valve housing and, when energized, generates an attracting force due to a magnetic force between the fixed core and the valve member, a coil housing that forms a magnetic path between the valve housing and the fixed core while surrounding the coil assembly, and a synthetic resin covering layer that is molded so as to cover the coil housing,
wherein a flange-shaped yoke supporting a front end of the coil assembly is formed on an outer periphery of the valve housing, the coil housing being formed from a body portion surrounding the coil assembly while being magnetically connected to the yoke and an end wall portion formed integrally with the body portion and fitted around an outer periphery of the fixed core, and a shoulder portion is formed on the outer periphery of the fixed core, the shoulder portion receiving the end wall portion and restricting the position of the coil housing in an axial direction.

2. The electromagnetic fuel injection valve according to claim 1, wherein
the end wall portion (23b) and the coil assembly are formed so that the end wall portion abuts against a rear end face of the coil assembly.

3. The electromagnetic fuel injection valve according to claim 1, wherein
the covering layer is formed by injecting a synthetic resin via a gate disposed to the rear of the end wall portion.

4. The electromagnetic fuel injection valve according to claim 1, wherein
a through hole is provided in the body portion, the through hole making a synthetic resin penetrate the coil assembly when molding the covering layer.

5. The electromagnetic fuel injection valve according to claim 4, wherein
the body portion is fitted around an outer periphery of the yoke, and a gap is provided in the fitted part, the gap enabling the synthetic resin to flow when molding the covering layer.
